(19) United States
(12) Patent Application Publication
(10) Pub. No.: US 2014/0150267 A1
(43) Pub. Date: Jun. 5, 2014

(54) HEAD FOR A TRIMMER AND ATTACHMENT THEREFOR

(71) Applicant: TECHTRONIC OUTDOOR PRODUCTS TECHNOLOGY LTD., Hamilton (BM)

(72) Inventors: Lee E. Sowell, Pelzer, SC (US); Robert Andrew Patrick, Simpsonville, SC (US)

(73) Assignee: TECHTRONIC OUTDOOR PRODUCTS TECHNOLOGY LIMITED, Hamilton (BM)

(21) Appl. No.: 13/692,029

(22) Filed: Dec. 3, 2012

(51) Int. Cl. A01D 34/416; A01D 34/90; A01D 34/84

(52) U.S. Cl. CPC A01D 34/4165; A01D 34/84; A01D 34/90; A01D 34/4166
USPC 30/123; 30/347; 30/276; 30/340

(57) ABSTRACT

A trimmer head for use with a trimmer. The trimmer head includes a housing rotatable about an axis, the housing defining a cavity for receiving a spool carrying a length of trimmer line, the housing further defining a housing mating feature. The trimmer head also includes a first cap member having a first mating feature formed as one piece with the first cap member and operable to cooperate with the housing mating feature. The trimmer head also includes a second cap member having a second mating feature formed as one piece with the second cap member and operable to cooperate with the housing mating feature. The second cap member provides a cutting feature independent from the trimmer line. The first cap member and the second cap member are releasably and interchangeably coupleable to the housing without the use of tools.

### FIELD

The present invention relates to landscape trimmers, and more particularly, to string heads or other heads for landscape trimmers.

### SUMMARY

Generally, landscape trimmers are used to cut grass and weeds, and are often used to edge around trees, near fences and walls, and along landscape borders. Conventional landscape trimmers include an elongated shaft with a rotating element or gear head near the end of the elongated shaft, and a spool or string head is attached to the gear head. Typically, the string head includes a monofilament line (i.e., trimmer line) that is rotated by the gear head for cutting and trimming along landscaped areas, fences, and walls.

In one construction, the invention provides a trimmer head for use with a trimmer. The trimmer head includes a housing rotatable about an axis, the housing defining a cavity and a housing mating feature, and a spool receivable in the cavity for carrying a length of trimmer line. The trimmer head also includes a first cap member having a first mating feature operable to cooperate with the housing mating feature to selectively and releasably couple the first cap member with the housing. The first mating feature is formed as one piece with the first cap member. The first cap member cooperates with the housing to retain the spool in the cavity. The trimmer head also includes a second cap member having a second mating feature operable to cooperate with the housing mating feature to selectively and releasably couple the second cap member with the housing. The second mating feature is formed as one piece with the second cap member. The second cap member provides a cutting feature independent from the trimmer line. The first cap member and the second cap member are releasably and interchangeably coupleable to the housing without the use of tools.

In another construction, the invention provides a landscape trimmer having a motor, an output shaft driven by the motor, and a trimmer head. The trimmer head includes a housing rotatable about an axis, the housing defining a cavity and a housing mating feature, and a spool receivable in the cavity for carrying a length of trimmer line. The trimmer head also includes a first cap member having a first mating feature operable to cooperate with the housing mating feature to selectively and releasably couple the first cap member with the housing. The first mating feature is formed as one piece with the first cap member, and the first cap member cooperates with the housing to retain the spool in the cavity. The trimmer head also includes a second cap member having a second mating feature operable to cooperate with the housing mating feature to selectively and releasably couple the second cap member with the housing. The second mating feature is formed as one piece with the second cap member. The second cap member provides a cutting feature independent from the trimmer line. The first cap member and the second cap member are releasably and interchangeably coupleable to the housing without the use of tools.

In yet another construction, the invention provides a trimmer head for use with a trimmer. The trimmer head includes a housing rotatable about an axis, the housing including a circumferential wall defining a cavity and a housing mating feature associated with the circumferential wall. A spool is receivable in the cavity for carrying a length of trimmer line. The trimmer head also includes a first cap member and a second cap member. The first cap member has a first mating feature operable to cooperate with the circumferential wall and the housing mating feature to selectively and releasably couple the first cap member with the housing. The first mating feature is formed as one piece with the first cap member. The first cap member cooperates with the housing to retain the spool in the cavity. The second cap member has a second mating feature operable to cooperate with the circumferential wall and the housing mating feature to selectively and releasably couple the second cap member with the housing, the second mating feature being formed as one piece with the second cap member. The second cap member provides a cutting feature independent from the trimmer line. The first cap member and the second cap member are releasably and interchangeably coupleable to the housing without the use of tools.

Other aspects of the invention will become apparent by consideration of the detailed description and accompanying drawings.

### BRIEF DESCRIPTION OF THE DRAWINGS

FIG. 1 is a perspective view of a landscape trimmer having a quick change head with blade cap member.

FIG. 2 is a perspective view of the landscape trimmer shown in FIG. 1 illustrating an exploded view of the quick change head with blade cap member.

FIG. 3 is a perspective view of a quick change head with spool and spool cap member.

FIG. 4 is a front perspective view of the quick change head shown in FIG. 1.

FIG. 5 is a front exploded view of the quick change head shown in FIG. 4.

FIG. 6 is a rear exploded view of the quick change head shown in FIG. 5.

FIG. 7 is a front exploded view of an alternative embodiment of a cap member with fixed line holders.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

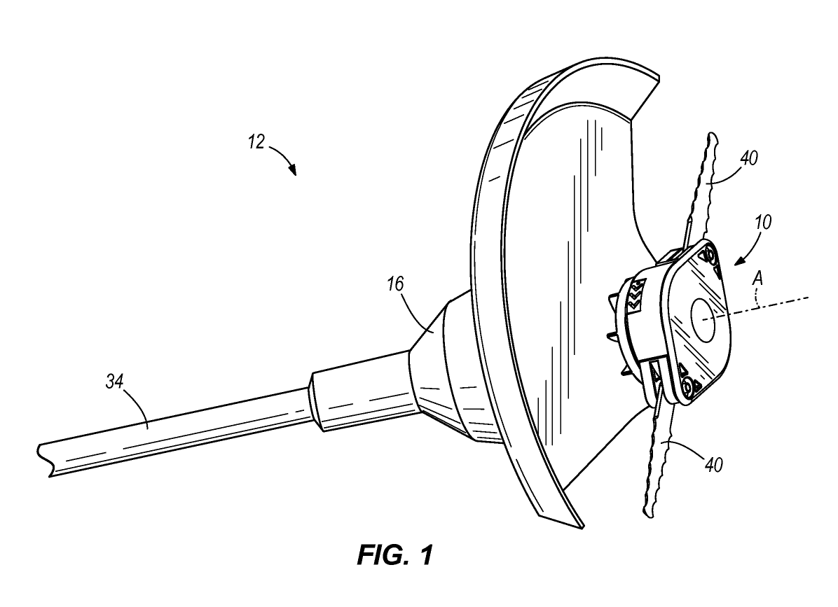

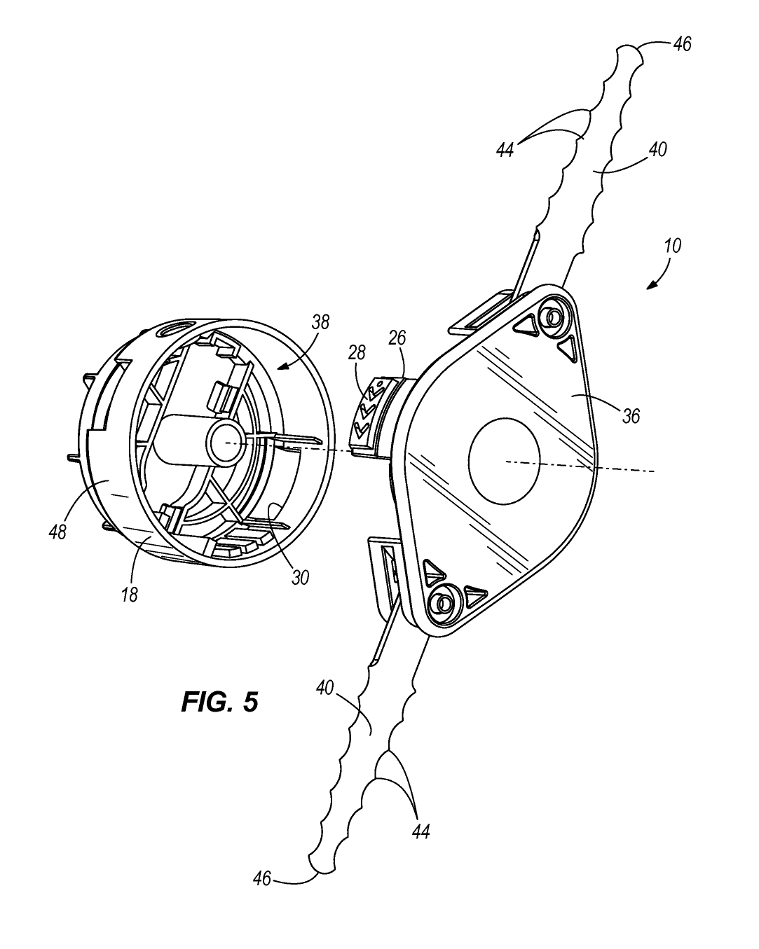

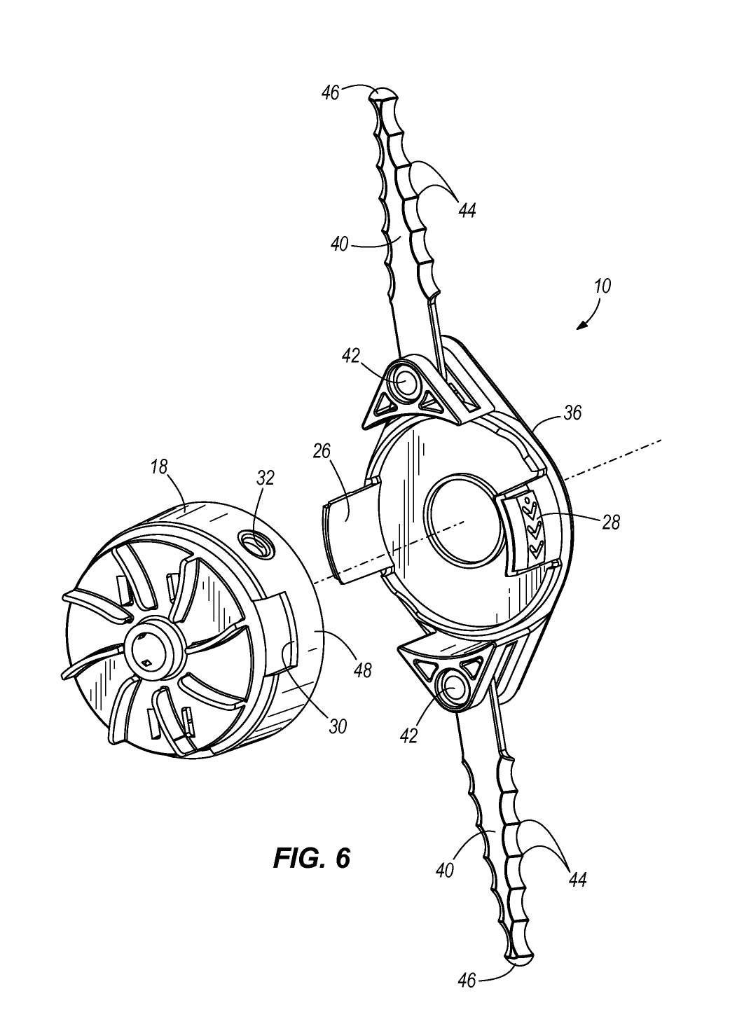

FIGS. 1-6 illustrate a trimmer head 10 for use on a powered trimmer 12. In the illustrated construction, the trimmer 12 is a hand-held powered trimmer including an elongated shaft 34 for supporting a handle with a grip (not shown). In other constructions (not shown), the trimmer 12 may be a different type of powered trimmer and, for example, may include a frame and wheels for movement over the ground.

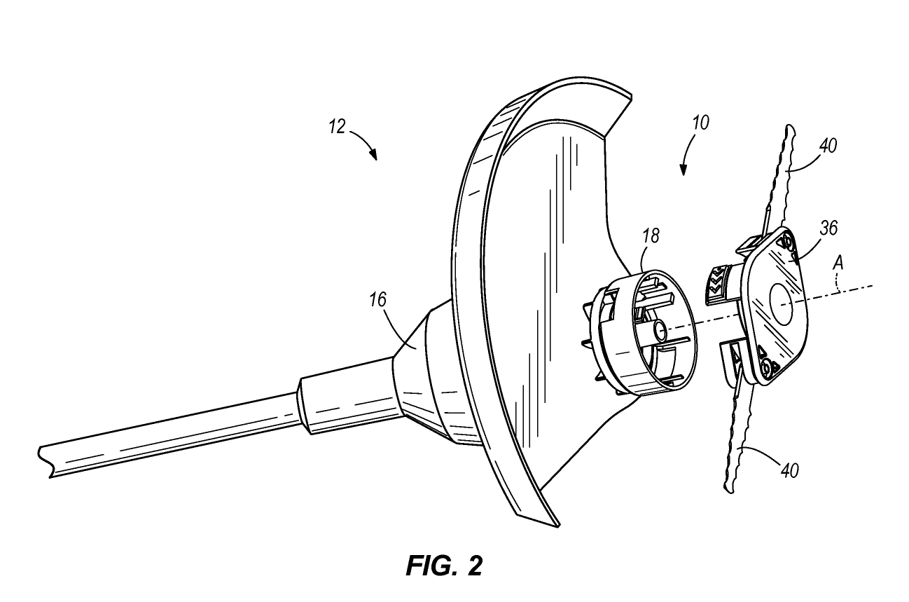

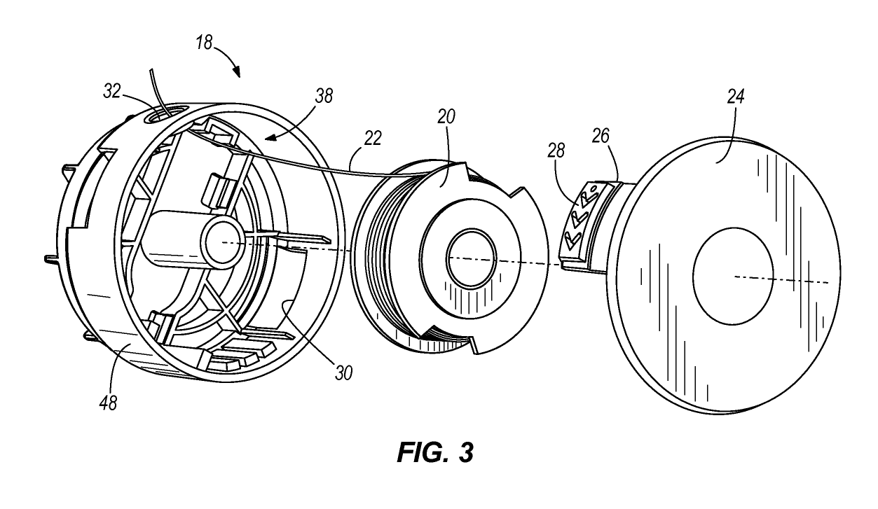

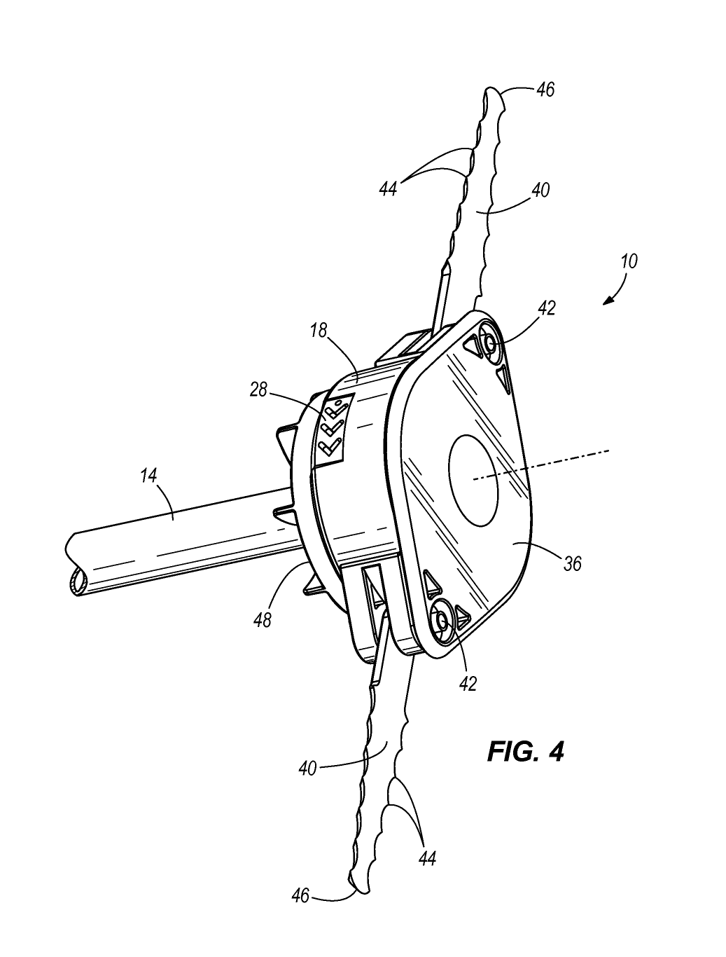

The trimmer 12 includes an output shaft 14 (FIG. 4) driven by a motor 16, such as a two-cycle gas engine, an electric motor, etc. As illustrated in FIGS. 1-2, the trimmer head 10 defines a central axis A and includes a housing 18 couplable to and rotatable with the output shaft 14. The housing 18 includes a circumferential wall 48 defining a cavity 38 and receives a spool 20 (FIG. 3) in the spool cavity 38. A cutting line 22 is wound about the spool 20. The trimmer head 10 may employ a bump-feed type spool, an auto-feed type spool, a fixed line spool, etc. For example, the trimmer 12 may employ the feed device described in U.S. patent application Ser. No. 12/691,811, filed Jan. 22, 2010, entitled, “STRING HEAD FOR A TRIMMER”, the entire contents of which are hereby incorporated by reference.

As illustrated in FIG. 3, the trimmer head 10 includes a first or spool cap member 24. The spool cap member 24 cooperates with the housing 18 to enclose and/or retain the spool 20 within the trimmer head 10. The housing 18 defines at least one line opening 32 through which the trimmer line 22 may pass. A portion of the trimmer line 22 positioned outside of the housing 18 may be used for cutting vegetation.

The spool cap member 24 includes a mating feature 26 for removably coupling the spool cap member 24 to a mating feature 30 of the housing 18. The housing mating feature 30 is associated with the circumferential wall 48 of the housing 18.

In the illustrated construction, the spool cap member 24 includes prongs 26 or snap-fits extending in an axial direction (parallel to axis A) for removably snap fitting with the housing 18, specifically with the circumferential wall 48 of the housing 18. In the illustrated construction, the mating feature 30 of the housing 18 includes circumferential openings 30 in the circumferential wall 48.

The prongs 26 include radial flanges 28 for mating with respective circumferential openings 30 in the circumferential wall 48. The flanges 28 are received in the respective openings 30 and are actuatable radially inwards towards the central axis A by a user from outside the housing 18 to remove the spool cap member 24 in the direction of the axis A (see FIG. 2). In the illustrated construction, the prongs 26, or mating features, are formed as one piece with the spool cap member 24. The circumferential openings 30, or mating features, are formed as one piece with the housing 18.

In other constructions (not shown), the mating features 26, 30 may include other types of snap-fit structures, configurations, shapes, etc. and may include only one or more than two prongs or snap-fit structures. Furthermore, in yet other constructions (not shown), the spool cap member 24 and housing 18 may be removably coupled by way of other types of other mating features, such as magnets, threads, connectors, fasteners, etc. Accordingly, the housing 18 may include other mating features corresponding to the structure of the mating features of the spool cap member 24.

Also, it should be understood that the mating features of the spool cap member 24 and the housing 18 may be reversed (e.g., the prongs 26 may be formed as one piece with the housing 18 (e.g., as a portion of the cylindrical wall 48), and the spool cap member 24 may include a circumferential wall having circumferential openings 30, etc.).

As illustrated in FIGS. 1-2 and 4-6, the trimmer head 10 also includes a second or accessory cap member 36 for providing an alternative functional feature in place of or in addition to the line 22. The spool cap member 24 and the accessory cap member 36 are releasably and interchangeably coupleable to the housing 18 without the use of tools. The accessory cap member 36 may be coupled to the housing 18 with or without the spool 20 enclosed therein.

The accessory cap member 36 cooperates with the housing 18 to enclose the spool cavity 38 in the same way as the spool cap member 24 described above. That is, the accessory cap member 36 includes the same mating feature as the spool cap member 24 such that the spool cap member 24 and the accessory cap member 36 are interchangeable. In the illustrated construction, the accessory cap member 36 includes prongs 26 with radial flanges 28 for mating with respective circumferential openings 30 in the housing 18, as described above.

As also described above, in other constructions (not shown) the accessory cap member 36 and the housing 18 may employ other snap-fit structures, configurations, shapes, sizes and types of mating features, and the mating features may be reversed. In other constructions (not shown), the mating features of the spool cap member 24 and the accessory cap member 36 may be different from each other but still able to cooperate with the housing mating feature 30 to selectively couple each cap member 24, 36 to the housing 18.

In the illustrated construction, the accessory cap member 36 includes blades 40. The blades 40 extend radially from the accessory cap member 36 and are pivotably coupled to the accessory cap member 36. In the illustrated construction, the blades 40 are coupled by way of pins 42; however, other types of connections may be employed. The blades 40 are generally tapered as they extend radially away from the accessory cap member 36. The blades 40 include teeth 44 along both opposing longitudinal edges and a beveled cutting edge 46 at a distal end thereof

In other constructions (not shown), other types of blades having other cutting features, shapes, toothforms, etc. may be employed. In other constructions (not shown), the accessory cap member 36 may include other accessories providing other functions to the trimmer head 10.

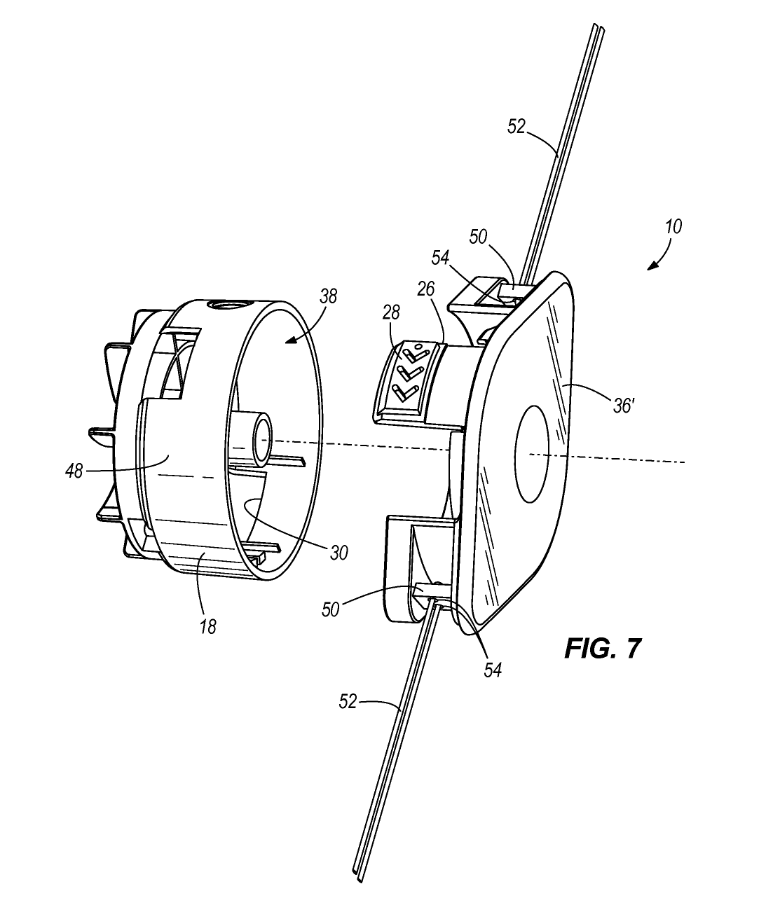

For example, FIG. 7 illustrates an accessory cap member 36′ including a fixed line holder 50. In the illustrated construction, the accessory cap member 36′ includes two fixed lines 52 held in place by two respective fixed line holders 50. However, in other constructions (not shown), the accessory cap member 36′ may include only one or more than two fixed line holders 50. Preferably, to balance the trimmer head 10, the fixed lines 50 are spaced approximately equidistantly about the circumference of the cap member 36′. In the illustrated construction, the fixed lines 50 are spaced approximately 180 degrees apart, i.e., substantially opposite from one another.

Each line 52 is fixedly coupled to the fixed line holder 50 of the accessory cap member 36′ by way of two substantially parallel through-holes 54 through which the line 52 is passed in succession at substantially the midpoint of the line 52.

In operation, a user may insert a spool 20 into the cavity 38 and attach a spool cap member 24 to the housing 18 and operate the trimmer 12 using the line 22 to cut vegetation. The user may remove the spool cap member 24 by pressing inwardly on the flanges 28 and pulling the spool cap member 24 out of engagement with the housing 18 in the axial direction. The user may replace the spool cap member 24 with the accessory cap member 36 with or without removing the spool 20 from the cavity 38. The user may then operate the trimmer 12 using the functionality of the accessory cap member 36. For example, the user may operate the trimmer 12 using blades 40 to cut vegetation.

Thus, the invention may provide, among other things, a quick-change trimmer head for a powered trimmer having various cap members providing different functional features and being interchangeable without the use of a tool. One or more independent features and independent advantages of the invention may be set forth in the following claims.

What is claimed is:

1. A trimmer head for use with a trimmer, the trimmer head comprising:
a housing rotatable about an axis, the housing defining a cavity for receiving a spool carrying a length of trimmer line, the housing further defining a housing mating feature;
a first cap member having a first mating feature operable to cooperate with the housing mating feature to selectively and releasably couple the first cap member with the housing, the first mating feature being formed as one piece with the first cap member, the first cap member cooperating with the housing to retain the spool in the cavity; and
a second cap member having a second mating feature operable to cooperate with the housing mating feature to selectively and releasably couple the second cap member with the housing, the second mating feature being formed as one piece with the second cap member, the second cap member providing a cutting feature independent from the trimmer line;
wherein the first cap member and the second cap member are releasably and interchangeably coupleable to the housing without the use of tools.

2. The trimmer head of claim 1, wherein the second mating feature is substantially identical to the first mating feature.

3. The trimmer head of claim 1, wherein the first mating feature and the second mating feature include snap-fits.

4. The trimmer head of claim 3, wherein at least one of the first mating feature and the second mating feature includes a prong and a flange for snap-fitting to the housing.

5. The trimmer head of claim 4, wherein the housing mating feature includes an opening in the housing for receiving the flange.

6. The trimmer head of claim 1, wherein the cutting feature provided by the second cap member includes at least one blade.

7. The trimmer head of claim 6, wherein the at least one blade is pivotably coupled to the second cap member and extends radially therefrom.

8. The trimmer head of claim 7, wherein the at least one blade includes cutting teeth.

9. The trimmer head of claim 8, wherein the cutting teeth are positioned along opposing longitudinal edges of the at least one blade.

10. The trimmer head of claim 9, wherein the at least one blade further includes a beveled cutting edge disposed at a distal end thereof.

11. The trimmer head of claim 1, wherein the cutting feature provided by the second cap member includes at least one fixed string.

12. A landscape trimmer comprising:
a motor;
an output shaft driven by the motor; and
a trimmer head including
a housing rotatable about an axis, the housing defining a cavity for receiving a spool carrying a length of trimmer line, the housing further defining a housing mating feature,
a first cap member having a first mating feature operable to cooperate with the housing mating feature to selectively and releasably couple the first cap member with the housing, the first mating feature being formed as one piece with the first cap member, the first cap member cooperating with the housing to retain the spool in the cavity, and
a second cap member having a second mating feature operable to cooperate with the housing mating feature to selectively and releasably couple the second cap member with the housing, the second mating feature being formed as one piece with the second cap member, the second cap member providing a cutting feature independent from the trimmer line,
wherein the first cap member and the second cap member are releasably and interchangeably coupleable to the housing without the use of tools.

13. The landscape trimmer of claim 12, wherein the second mating feature is substantially identical to the first mating feature.

14. The landscape trimmer of claim 12, wherein the first mating feature and the second mating feature include snap-fits.

15. The landscape trimmer of claim 14, wherein at least one of the first mating feature and the second mating feature includes a prong and a flange for snap-fitting to the housing.

16. The landscape trimmer of claim 15, wherein the housing mating feature includes an opening in the housing for receiving the flange.

17. The landscape trimmer of claim 12, wherein the cutting feature provided by the second cap member includes at least one blade.

18. The landscape trimmer of claim 17, wherein the at least one blade is pivotably coupled to the second cap member and extends radially therefrom.

19. The landscape trimmer of claim 18, wherein the at least one blade includes cutting teeth.

20. The landscape trimmer of claim 19, wherein the cutting teeth are positioned along opposing longitudinal edges of the at least one blade.

21. The landscape trimmer of claim 20, wherein the at least one blade further includes a beveled cutting edge disposed at a distal end thereof.

22. The landscape trimmer of claim 12, wherein the cutting feature provided by the second cap member includes at least one fixed string.

23. An attachment for a landscape trimmer having a trimmer head including a housing rotatable about an axis, the housing defining a cavity for receiving a spool carrying a length of trimmer line, the housing further defining a housing mating feature, the attachment comprising:
a cap member providing a cutting feature; and
a cap mating feature operable to cooperate with the housing mating feature for selectively and releasably coupling the cap member with the landscape trimmer, the cap mating feature being formed as one piece with the cap member;
wherein the cap member is releasably coupleable to the landscape trimmer without the use of tools or fasteners.

24. The attachment of claim 23, wherein the cap mating feature includes at least one prong extending away from the cap member, the prong including a flange for cooperating with the housing mating feature to selectively and releasably couple the cap member with the landscape trimmer.

25. The attachment of claim 23, wherein the cap member includes a substantially planar portion carrying the cutting feature, and wherein the cap mating feature generally extends away from the substantially planar portion in a direction substantially perpendicular to the substantially planar portion.

26. The attachment of claim 25, wherein the substantially planar portion includes an outer periphery, and wherein the cap mating feature extends substantially from the outer periphery.

27. The attachment of claim 23, wherein the cutting feature includes at least one blade pivotably coupled to the cap member.

28. The attachment of claim 27, wherein the blade includes teeth disposed along a longitudinal edge of the blade, and wherein the blade further includes a beveled cutting edge disposed at a distal end of the blade.

29. The attachment of claim 23, wherein the cutting feature includes at least one fixed string coupled to the cap member.

30. A trimmer head for use with a trimmer, the trimmer head comprising:
a housing rotatable about an axis, the housing including a circumferential wall defining a cavity for receiving a spool carrying a length of trimmer line, the housing further defining a housing mating feature associated with the circumferential wall;
a first cap member having a first mating feature operable to cooperate with the circumferential wall and the housing mating feature to selectively and releasably couple the first cap member with the housing, the first mating feature being formed as one piece with the first cap member, the first cap member cooperating with the housing to retain the spool in the cavity; and
a second cap member having a second mating feature operable to cooperate with the circumferential wall and the housing mating feature to selectively and releasably couple the second cap member with the housing, the second mating feature being formed as one piece with the second cap member, the second cap member providing a cutting feature independent from the trimmer line;
wherein the first cap member and the second cap member are releasably and interchangeably coupleable to the housing without the use of tools.

31. The trimmer head of claim 30, wherein the housing mating feature includes an opening in the circumferential wall, and wherein at least one of the first mating feature and the second mating feature includes a prong projecting axially from an associated one of the first cap member and the second cap member and communicating with the circumferential wall and the opening to snap-fit to the housing.

32. The trimmer head of claim 31, wherein the cutting feature provided by the second cap member includes a blade having teeth and a beveled cutting edge.

33. The trimmer head of claim 31, wherein the cutting feature provided by the second cap member includes a fixed string.
